(19) United States
(12) Patent Application Publication
(10) Pub. No.: US 2025/0247769 A1
(43) Pub. Date: Jul. 31, 2025

(54) METHODS AND SYSTEMS FOR CONTROLLING MBSR BEHAVIOUR

(71) Applicant: Samsung Electronics Co., Ltd., Gyeonggi-do (KR)

(72) Inventors: Lalith KUMAR, Bangalore (IN); Aman AGARWAL, Bangalore (IN); Avneesh TIWARI, Bangalore (IN); Kailash Kumar JHA, Bangalore (IN)

(21) Appl. No.: 19/102,096

(22) PCT Filed: Aug. 8, 2023
(86) PCT No.: PCT/KR2023/011702

§ 371 Date: Feb. 7, 2025

(30) Foreign Application Priority Data
Aug. 9, 2022 (IN) 202241045544
Oct. 7, 2022 (IN) 202241057572
Jul. 15, 2023 (IN) 202241045544

(51) Int. Cl. H04W 48/04; H04W 48/18; H04W 60/00; H04W 84/04

(52) U.S. Cl. CPC H04W 48/04; H04W 48/18; H04W 60/00; H04W 84/042

(57) ABSTRACT

Embodiments herein disclose methods and systems for providing network control for MBSR behaviour in wireless communication networks. Embodiments herein disclose methods and systems for the HPLMN/EHPLMN or the serving/registered PLMN or any PLMN in any of the UE's preferred lists to selectively control the UE behaviour to either act as a normal UE or as a UE (MBSR) based on either the PLMN serving the UE or the location of the UE. Embodiments herein disclose methods and systems for the HPLMN to control/prioritize/restrict certain PLMN(s) for UE, to operate as UE (MBSR), over other PLMN(s). Embodiments herein disclose methods and systems for determining which UEs are allowed or not allowed to operate as a MBSR UE (with mobile relay operation) in specific areas/PLMNs/geographical locations/TACs/TAIs.

### TECHNICAL FIELD

Embodiments disclosed herein relate to wireless communication networks, and more particularly to methods and systems for providing network control for MBSR behaviour in wireless communication networks.

### BACKGROUND ART

5G mobile communication technologies define broad frequency bands such that high transmission rates and new services are possible, and can be implemented not only in “Sub 6GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to disclose methods and systems for providing network control for MBSR behaviour in wireless communication networks.

Another object of the embodiments herein is to disclose methods and systems for the HPLMN/EHPLMN or the serving/registered PLMN or any PLMN in any of the UE's preferred lists (for example, EHPLMN List, OPLMN list, UPLMN list etc.) to selectively control (enable/disable) the UE behaviour to either act as a normal UE or as a UE (MBSR) based on either the PLMN serving the UE (i.e., the PLMN on which the UE is camped and/or registered) or the location of the UE (i.e., based on Home Area, Roaming Area within the same country/Mobile Country Code (MCC) of the HPLMN or Roaming Area outside the country/MCC of the HPLMN).

Another object of the embodiments herein is to disclose methods and systems for the HPLMN to control/prioritize/restrict certain PLMN(s) for UE, to operate as UE (MBSR), over other PLMN(s).

Another object of the embodiments herein is to disclose methods and systems for determining which UEs are allowed or not allowed to operate as a MBSR UE (with mobile relay operation) in specific areas/PLMNs/geographical locations/TACs/TAIs.

### Solution to Problem

Accordingly, the embodiments herein provide a method for managing behaviour of a User Equipment (UE) in a wireless network. The method comprises the UE receiving a reject message from a network entity, if the UE is not authorized to operate as a Mobile Base Station Relay (MBSR). The UE can determine at least one forbidden area to operate as a MBSR, on receiving the reject message from the network entity. The UE can remain registered with the network entity, on determining that the UE can operate as MBSR, and a current camped area is not a forbidden area. On determining that the UE is not allowed to operate as MBSR and current area is a forbidden area, the UE can trigger a registration procedure and indicate no support of MBSR to the network entity, to not operate as a MBSR, enter a limited service state or PLMN search state; and perform PLMN selection procedure.

Accordingly, the embodiments herein provide a User Equipment (UE) comprising a processor; a memory; and an access controller, wherein the access controller is coupled with the processor and the memory. The UE can receive a reject message from a network entity, if the UE is not authorized to operate as a Mobile Base Station Relay (MBSR); and determine at least one forbidden area to operate as a MBSR, on receiving the reject message from the network entity. The UE can remain registered with the network entity in response to determining that the UE can operate as MBSR, and a current camped area is not a forbidden area. On determining that the UE is not allowed to operate as MBSR and current area is a forbidden area, the UE can trigger a registration procedure and indicating no support of MBSR to the network entity, to not operate as a MBSR, enter a limited service state or PLMN search state, and perform a PLMN selection procedure.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 is a diagram illustrating the IAB architecture according to embodiments as disclosed herein;

FIG. 2 is a diagram illustrating MBSR according to embodiments as disclosed herein;

FIG. 3 is a flow diagram illustrating a scenario, wherein the UE is unable to determine the areas/PLMNs/geographical locations/TACs/TAIs according to embodiments as disclosed herein;

FIG. 4 is a flow diagram illustrating the process of a UE attempting to register as a MBSR.

FIG. 5 is a diagram illustrating a communication network, comprising one or more network entities and one or more UEs, according to embodiments as disclosed herein;

FIG. 6 is a diagram illustrating an example scenario, wherein one or more UEs are connected to the network entity, according to embodiments as disclosed herein;

FIG. 7 is a diagram illustrating components of the UE, according to embodiments as disclosed herein;

FIG. 8 is a flow diagram illustrating a process to selectively control the UE behaviour to either act as a normal UE or as a UE (MBSR), according to embodiments as disclosed herein;

FIG. 9 is a flow diagram illustrating a method to control certain PLMN(s) for UE, to operate as UE (MBSR), over other PLMN(s), according to embodiments as disclosed herein;

FIG. 10 is a flow diagram illustrating a process of a UE performing registration or attempting registration to the network, according to embodiments as disclosed herein; and

FIG. 11 is a flow diagram illustrating a process of a UE performing registration or attempting registration to the network, according to embodiments as disclosed herein.

### BEST MODE FOR CARRYING OUT THE INVENTION

The embodiments herein provide a method (400) for managing behaviour of a User Equipment (UE) (502) in a wireless network. The method comprises receiving, by the UE (502), a reject message from a network entity (501), if the UE (502) is not authorized to operate as a Mobile Base Station Relay (MBSR); determining, by the UE (502), at least one forbidden area to operate as a MBSR, on receiving the reject message from the network entity (501); and performing by the UE (502) at least one of: remaining registered with the network entity (502) in response to determining that the UE can operate as MBSR, and a current camped area is not a forbidden area; and on determining that the UE is not allowed to operate as MBSR and current area is a forbidden area, performing: triggering a registration procedure and indicating no support of MBSR to the network entity (501), to not operate as a MBSR; entering a limited service state or PLMN search state; and performing a PLMN selection procedure.

The determining by the UE the forbidden area further comprises of at least one of determining: the area received in the reject message as the forbidden area, on receiving the forbidden area in the reject message; and the current camped area as the forbidden area, in response to not receiving the forbidden area in the reject message.

The reject message is a Non-access stratum (NAS) message.

The NAS message is at least one of a registration accept message, a UE configuration update command, and a deregistration request message.

The area is at least one of a PLMN ID, Tracking Area Identity (TAI), cell ID and a geographical location.

The method further comprises triggering, by the UE, a registration procedure for operating as the MBSR, on the UE not being present in the forbidden area.

Accordingly the embodiments herein provides a User Equipment (UE) (502) comprising: a processor; a memory; and an access controller, coupled with the processor and the memory, configured to: receive a reject message from a network entity (501), if the UE (502) is not authorized to operate as a Mobile Base Station Relay (MBSR); and determine at least one forbidden area to operate as a MBSR, on receiving the reject message from the network entity (501); perform at least one of: remain registered with the network entity (502) in response to determining that the UE can operate as MBSR, and a current camped area is not a forbidden area; and on determining that the UE is not allowed to operate as MBSR and current area is a forbidden area: trigger a registration procedure and indicating no support of MBSR to the network entity (501), to not operate as a MBSR; enter a limited service state or PLMN search state; and perform a PLMN selection procedure.

The UE (502) is configured to determine the forbidden area by performing of at least one of: determining the area received in the reject message as the forbidden area, on receiving the forbidden area in the reject message; and determining the current camped area as the forbidden area, in response to not receiving the forbidden area in the reject message.

The UE is further configured to trigger a registration procedure for operating as the MBSR, on the UE not being present in the forbidden area.

### Mode for the Invention

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

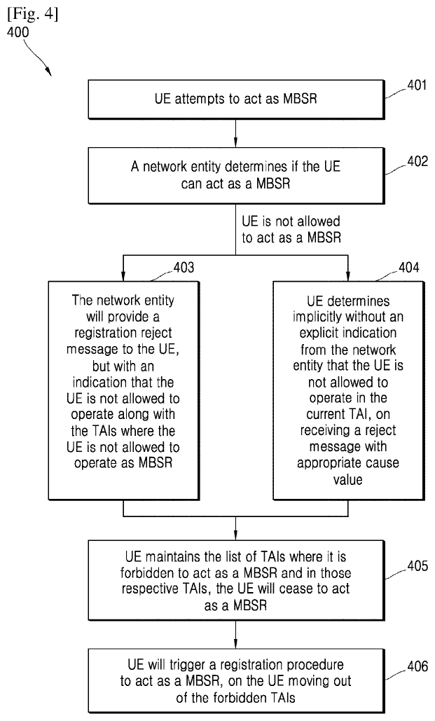

The embodiments herein achieve methods and systems for providing network control for MBSR behaviour in wireless communication networks. Referring now to the drawings, and more particularly to FIGS. 4 through 11, where similar reference characters denote corresponding features consistently throughout the figures, there are shown example embodiments.

The following definitions and abbreviations have been referred to herein:
TN: Terrestrial Network
AS: Access Stratum
NAS: Non-Access Stratum
MS: Mobile Station
UE: User Equipment
ME: Mobile Equipment
USIM: Universal Subscriber Identity Module
gNB: Next generation Node-B
gNB: DU: Next generation Node-B Distributive Unit
gNB: CU: Next generation Node-B Control Unit
SNPN: Stand-alone Non-Public Network
NR: New Radio
5GC: 5G Core
NW: Network
IAB: Integrated access and backhaul
IAB-UE: The part of the IAB node that supports the Uu interface towards the IAB-donor or another parent IAB-node (and thus manages the backhaul connectivity with either PLMN or SNPN it is registered with) is referred to as an IAB-UE.
NG-RAN: Next Generation Radio Access Network
NR: New Radio
MBSR: Mobile Base Station Relay
PLMN: Public Land Mobile Network
HPLMN: Home Public Land Mobile Network
VPLMN: Visited Public Land Mobile Network
FPLMN: Forbidden Public Land Mobile Network
PLMN ID: Public Land Mobile Network Identity
UCU: UE Configuration Update
UPU: UE Policy Update
LCS: Location services
AMF: Access and Mobility Management Function
3GPP: Third Generation Partnership Project
Satellite: an artificial body placed in orbit round the earth or moon or another planet to collect information or for communication.
Satellite Constellation: A group of satellites, placed in orbit round the earth or moon or another planet to collect information or for communication.
Service User: An individual who has received a priority level assignment from a regional/national authority (i.e., an agency authorised to issue priority assignments) and has a subscription to a mobile network operator.

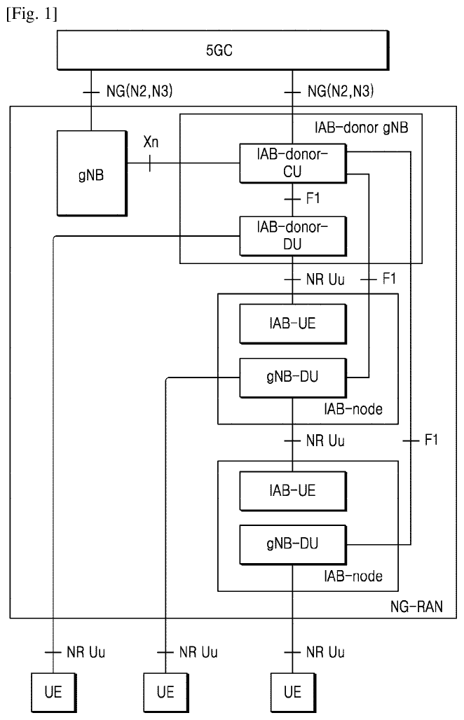

Integrated access and backhaul (IAB) enables wireless in-band and out-of-band relaying of NR Uu access traffic via NR Uu backhaul links. The Uu backhaul links can exist between the IAB-node and a gNB referred to as IAB-donor; or another IAB-node. The part of the IAB node that supports the Uu interface towards the IAB-donor or another parent IAB-node (and thus manages the backhaul connectivity with either PLMN or SNPN it is registered with) is referred to as an IAB-UE. FIG. 1 depicts the IAB architecture.

An IAB Node comprises of two modules: IAB-UE and, gNB-DU.

### Mobile Base Station relay (MBSR) (i.e., a mobile IAB-Node)

The mobile base station relays (as depicted in FIG. 2) uses the IAB architecture. The mobile base station relay has a single hop to the IAB-donor node. The mobile base station relay may serve UEs located inside or outside the vehicle mounted with the relay. NR Uu is used for the radio link between a mobile base station relay and served UEs, and between mobile base station relay and IAB-donor node. LCS framework is used for providing the location service to the served UEs. The mobile base station may connect to an IAB-donor node of a PLMN or an SNPN.

The 5G system shall support the mobile base station relay (i.e., IAB-node) having a subscription with a HPLMN and roaming from its HPLMN into a VPLMN. When using the IAB architecture, a mobile base station relay (i.e., IAB-node) consists of a gNB-DU and an IAB-UE. For roaming, the IAB-UE behaves as a UE, and thus may be able to access a VPLMN reusing UE procedures. However, to support the gNB-DU component of the mobile base station to operate properly in the VPLMN, additional support may need to be defined. Further, whether and how to support the controlling of a mobile base station relay, e.g., enable/disable mobile relay operation if the relay is roaming in a VPLMN needs to be defined.

### PLMN selection as per 23.122 without RPLMN

The MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

### PLMN selection as per 23.122 with RPLMN

The MS selects and attempts registration on any PLMN/access technology combinations, if available and allowable, in the following order:
either the RPLMN or the Last registered PLMN;
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

A UE can behave as an MBSR (i.e., mobile IAB node) when UE provides an IAB-indication to the IAB-donor-CU; i.e. it shows intention of acting as MBSR, optionally during the RRC connection establishment and on the basis of the subscription data for IAB operation, selected AMF (by the IAB-donor-CU), optionally, performs the IAB authorization during the UE registration procedure/UE context setup procedure/modification procedure. However, a UE can behave as a normal UE/UE (No MBSR)/UE (without mobile relay operation)/UE (without Mobile Base Station Relay operation) or as a UE (With mobile relay operation)/UE (MBSR))/UE (with Mobile Base Station Relay operation), optionally using the IAB authorization on the basis of subscription data of the UE. The charging or pricing or policy for the UE, as applied by the serving PLMN, might be different for the UE (with mobile relay operation) and the UE (without mobile relay operation). Moreover, the UE may be served by the HPLMN, or the UE may be present in a roaming area or served by the VPLMN or any other PLMN.

In case of roaming, i.e., when the UE is roaming in a VPLMN, due to differential policy and charging requirements (different revenue/charges) applied by the PLMN(s) (i.e., VPLMN), the Home Operator or the Home PLMN (HPLMN) might be willing to selectively control (i.e., enable or disable) the UE behaviour to either act as a normal UE (No MBSR/without mobile relay operation) or as a UE (with MBSR/with mobile relay operation) based on either the PLMN serving the UE (i.e., the PLMN on which the UE is camped and/or registered) or the location of the UE (i.e., based on Home Area, Roaming Area within the same country/Mobile Country Code (MCC) of the HPLMN or Roaming Area outside the country/MCC of the HPLMN).

But, currently, there is no method for the HPLMN/EHPLMN or the serving/registered PLMN or any PLMN in any of the UE's preferred lists (for example, EHPLMN List, OPLMN list, UPLMN list etc.) to selectively control (enable/disable) the UE behaviour to either act as a normal UE or as a UE (MBSR) based on either the PLMN serving the UE (i.e., the PLMN on which the UE is camped and/or registered) or the location of the UE (i.e., based on Home Area, Roaming Area within the same country/Mobile Country Code (MCC) of the HPLMN or Roaming Area outside the country/MCC of the HPLMN) and a method needs to be defined.

Also, the UE might behave as a normal UE or as a UE (MBSR), optionally using the IAB authorization. In either of the cases, there may be some PLMNs/area in which UE is allowed or not allowed to act as MBSR but may/may not behave as a normal UE. In those cases, Home Operator or the Home PLMN (HPLMN) or the EHPLMN or the serving/registered PLMN or any PLMN in any of the UE's preferred lists (for example, EHPLMN List, OPLMN list, UPLMN list etc.) might be willing to control or prioritize or restrict certain PLMN(s) over other PLMN(s) for the UE to operate as a MBSR Node or as a Normal UE.

But, currently, there is no method defined for the HPLMN or the EHPLMN or the serving/registered PLMN or any PLMN in any of the UE's preferred lists (for example, EHPLMN List, OPLMN list, UPLMN list etc.) to control/prioritize/restrict certain PLMN(s) for UE, to operate as UE (MBSR), over other PLMN(s) and a method needs to be defined.

A UE can behave as an MBSR (i.e., mobile IAB node) when the UE provides an IAB-indication to the IAB-donor-CU during the RRC connection establishment and on the basis of the subscription data for IAB operation, selected AMF (by the IAB-donor-CU) performs the IAB authorization during the UE registration procedure/UE context setup procedure/modification procedure.

However, a UE can behave either as a normal UE/UE (No MBSR)/UE (without mobile relay operation) or as a UE (with mobile relay operation)/UE (MBSR) using the IAB authorization on the basis of subscription data of the UE.

As per existing methods/procedures, when a UE performs registration or attempts to register to the network in any area or PLMN (for example, roaming area or VPLMN or any PLMN) as a UE (with mobile relay operation)/UE (MBSR) using the IAB authorization, either,
The AMF may accept the Registration Request of the mobile base station relay, if the UE is allowed to act as a MBSR; or
The AMF may reject the Registration Request of the mobile base station relay with a 5GMM cause value indicating that the mobile base station relay is not allowed to operate as a relay (to act as MBSR) in the VPLMN area or any roaming area or in any PLMN.

In case of Registration reject or any AS/NAS signalling indicating a reject message from the AMF or the Network, for the UE with a 5GMM cause value indicating that the UE is not allowed to operate as a Mobile Base Station Relay in the VPLMN area or any roaming area or any selected PLMN, it is not defined and not clear as how the UE can determine that in which areas/PLMNs/geographical locations/TACs/TAIs, UE is allowed to operate as a MBSR UE (with mobile relay operation).

In order to determine in which areas/PLMNs/geographical locations/TACs/TAIs, the UE is allowed or not allowed to operate as a MBSR UE (with mobile relay operation), if the UE has to send a registration request or any AS/NAS signalling to the Network/AMF, this may unnecessarily increase the signalling overload between the UE and the Network/AMF.

Also, if the UE is registered on a PLMN or present in an area/geographical location/TAC/TAI in which it is allowed to act as MBSR for a given time-period/time-slot/time-window/time, but after the expiry of the timer/time-period/time-slot/time-window or after the subscription has expired or PLMN determines that the UE is not allowed to act as MBSR, then in that case also, the UE will not be able to determine the areas/PLMNs/geographical locations/TACs/TAIs, UE is allowed or not allowed to operate as a MBSR UE (with mobile relay operation) and may have to send a registration request or any AS/NAS signalling to the Network/AMF. This may also unnecessarily increase the signalling overload between the UE and the Network/AMF.

The mobile base station relay (UE with mobile base station relay operation) initiates a registration procedure and indicates its intention to operate as a Mobile Base Station Relay in RRC connection or any AS/NAS signaling message to the Network (for example, NG-RAN/AMF).

The Network Entity or Function may include the UE's capability/intention to operate as a Mobile Base Station Relay in any of the message/parameter while indicating to other Network Entity or function (for example, the intention of UE to operate as a Mobile Base Station Relay may be included in the N2 parameters to the AMF by the NG-RAN).

AMF may perform the Mobile Base Station Relay authorization (IAB-authorization) for the UE with the UDM. AMF or any Network Function may determine whether the UE is allowed to operate as a Mobile Base Station Relay (MBSR) in the selected or camped PLMN or not.

If the Network (for example, AMF or AUSF or UDM etc) determines UE is not allowed to operate as a Mobile Base Station Relay (MBSR) in the selected or camped PLMN, the Network (for example, the AMF or the NG-RAN) sends Registration Reject with 5GMM Cause UE is not allowed to operate as a mobile base station relay.

In order to determine that in which areas/PLMNs/geographical locations/TACs/TAIs, the UE is allowed or not allowed to operate as a MBSR UE (with mobile relay operation), the UE has to send a registration request or any AS/NAS signalling to the Network/AMF, this may unnecessarily increase the signalling overload between the UE and the Network/AMF.

Also if UE is registered on a PLMN or present in an area/geographical location/TAC/TAI in which it is allowed to act as MBSR for a given time-period/time-slot/time-window/time but after the expiry of the timer/time-period/time-slot/time-window or after the subscription has expired or PLMN determines that the UE is not allowed to act as MBSR, then in that case, the UE will not be able to determine the areas/PLMNs/geographical locations/TACs/TAIs, the UE is allowed or not allowed to operate as a MBSR UE (with mobile relay operation) and have to send a registration request or any AS/NAS signalling to the Network/AMF, this may also unnecessarily increase the signalling overload between the UE and the Network/AMF.

Thus, these issues need to be addressed in 3GPP perspective and it is desirable to solve such issues. Hence a method needs to be defined for these issues.

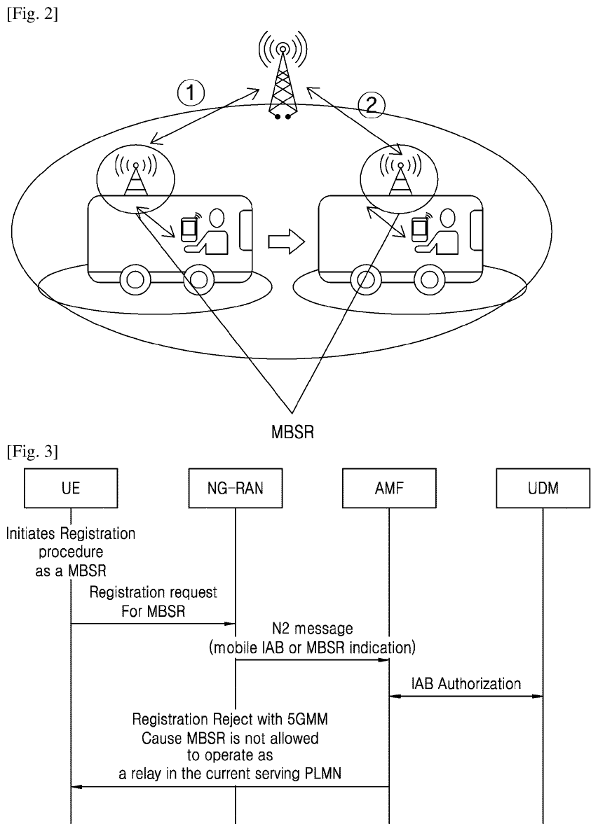

FIG. 3 depicts a scenario, wherein the UE is unable to determine the areas/PLMNs/geographical locations/TACs/TAIs. The mobile base station relay (UE with mobile base station relay operation) initiates a registration procedure and indicates its intention to operate as a Mobile Base Station Relay in RRC connection or any AS/NAS signaling message to the Network (for example, NG-RAN). The Network Entity or Function may include the UE's Capability to operate as a Mobile Base Station Relay in any of the message/parameter while indicating to other Network Entity or function (for example, the intention of UE to operate as a Mobile Base Station Relay may be included in the N2 parameters to the AMF by the NG-RAN). The AMF may perform the Mobile Base Station Relay authorization (IAB-authorization) for the UE with the UDM. The AMF or any Network Function may determine whether the UE is allowed to operate as a Mobile Base Station Relay (MBSR) in the selected or camped PLMN or not. If the Network (for example, AMF or AUSF or UDM etc.) determines that the UE is not allowed to operate as a Mobile Base Station Relay (MBSR) in the selected or camped PLMN, the Network (for example, the AMF or the NG-RAN) sends a Registration Reject with 5GMM as the UE is not allowed to operate as a mobile base station relay. In order to determine that in which areas/PLMNs/geographical locations/TACs/TAIs, the UE is allowed or not allowed to operate as a MBSR UE (with mobile relay operation), the UE have to send a registration request or any AS/NAS signalling to the Network/AMF, this may unnecessarily increase the signalling overload between the UE and the Network/AMF. Also, if the UE is registered on a PLMN or present in an area/geographical location/TAC/TAI in which it is allowed to act as MBSR for a given time-period/time-slot/time-window/time but after the expiry of the timer/time-period/time-slot/time-window or after the subscription has expired or PLMN determines that the UE is not allowed to act as MBSR, then in that case also, the UE will not be able to determine the areas/PLMNs/geographical locations/TACs/TAIs, the UE is allowed or not allowed to operate as a MBSR UE (with mobile relay operation) and have to send a registration request or any AS/NAS signalling to the Network/AMF, this may also unnecessarily increase the signalling overload between the UE and the Network/AMF.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT, and so on.

The terms mobile base station relay, IAB-Node, relay node, MBSR, UE (With mobile relay operation), UE (MBSR) and UE (with Mobile Base Station Relay operation) are used interchangeably and have the same meaning. These terms refer to the UE which has the IAB-node Capability and may function as mobile base station relay or the UE as a relay node.

The terms normal UE, UE (NO-MBSR), UE (without mobile relay operation) and UE (without Mobile Base Station Relay operation) is used interchangeably and have the same meaning. These terms refer to the UE which may or may not have the IAB-node capability and does not function as a mobile base station relay or doesn't function as the UE with a relay node.

The terms camp and register are used interchangeably and have the same meaning.

The term area as used in this embodiment may refer to any of cell/cell ID, TAC/TAI, PLMN, MCC/MNC or combination of MCC and MNC, Latitude/longitude, or any area identified using the geographical location/coordinate.

Embodiments herein provide methods and systems for providing network control for MBSR behaviour in wireless communication networks. Embodiments herein provide methods and systems for the HPLMN/EHPLMN or the serving/registered PLMN or any PLMN in any of the UE's preferred lists (for example, EHPLMN List, OPLMN list, UPLMN list etc.) to selectively control (enable/disable) the UE behaviour to either act as a normal UE or as a UE (MBSR) based on either the PLMN serving the UE (i.e., the PLMN on which the UE is camped and/or registered) or the location of the UE (i.e., based on Home Area/Area served by HPLMN/EHPLMN, Roaming Area within the same country/Mobile Country Code (MCC) of the HPLMN or Roaming Area outside the country/MCC of the HPLMN). Embodiments herein provide methods and systems for the HPLMN or the EHPLMN or the serving/registered PLMN or any PLMN in any of the UE's preferred lists (for example, EHPLMN List, OPLMN list, UPLMN list etc.) to control/prioritize/restrict certain PLMN(s) for UE, to operate as UE (MBSR), over other PLMN(s).

FIG. 4 is a flowchart depicting the process of a UE attempting to register as a MBSR. In step 401, a UE attempts to act as MBSR. In step 402, a network entity (such as, but not limited to, an AMF) determines if the UE can act as a MBSR. If the UE is not allowed to act as a MBSR then in step 403, the network entity will provide a NAS reject message to the UE, but with an indication that the UE is not allowed to operate along with the TAIs where the UE is not allowed to operate as MBSR. The NAS reject message can be at least one of the registration accept and registration reject message or any other message. When a reject message is provided with appropriate cause value optionally, if the area is not included, in step 404, the UE determines implicitly without an explicit indication from the network entity that the UE is not allowed to operate in the current TAI/cell/area/geographical location/PLMN. That is dynamically an area is configured by the network entity in which the UE is not allowed to operate as a MBSR. The UE can remain registered with the network entity in response to determining that the UE can operate as MBSR, and a current camped area is not a forbidden area. On determining that the UE is not allowed to operate as MBSR and optionally, the current area is a forbidden area, the UE can perform at least one of the trigger registration procedure and indicate no support or no intention of acting as MBSR to the network; i.e., to not operate as a MBSR, and the UE can further enter a limited service state or PLMN search state, and perform a PLMN selection procedure. In step 405, the UE maintains the list of TAIs where it is forbidden to act as a MBSR and in those respective TAIs, the UE will cease to act as a MBSR. On the UE moving out of the forbidden TAIs, in step 406, the UE will trigger a registration procedure to act as a MBSR. The various actions in method 400 may be performed in the order presented, in a different order or simultaneously. Further, in some embodiments, some actions listed in FIG. 4 may be omitted.

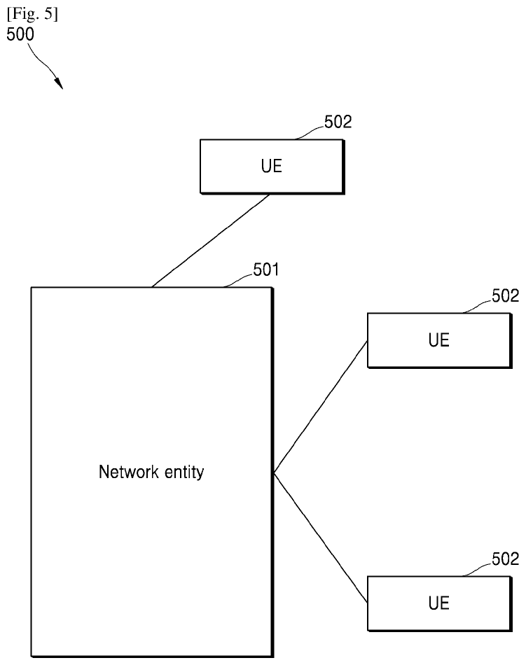

FIG. 5 depicts a communication network, comprising one or more network entities and one or more UEs. The network 500, as depicted, comprises one or more network entities 501, and one or more UEs 502. Examples of the one or more network entities 501 can be a NG-RAN, an AMF, a Unified Data Management (UDM), an Authentication Server Function (AUSF), a gNB, and so on.

The UE 502 can either act as a normal UE or as a UE (MBSR) based on either the PLMN serving the UE (i.e., the PLMN on which the UE is camped and/or registered) or the location of the UE (i.e., based on Home Area/Area served by HPLMN/EHPLMN, Roaming Area within the same country/Mobile Country Code (MCC) of the HPLMN or Roaming Area outside the country/MCC of the HPLMN).

The UE(s) 502 shall be configured by the Home Operator or the Home PLMN (HPLMN)/EHPLMN/VPLMN or any of the RPLMNs or the EHPLMN or the serving/registered PLMN or any PLMN in any of the UE's preferred lists (for example, EHPLMN List, OPLMN list, UPLMN list etc.) in a suitable AS/NAS signaling message (for example, Registration Accept message, UE Configuration Update (UCU) Command/message, UE Parameters Update (UPU) command/message, registration reject message etc.). In an embodiment herein, the network entity 501 can use a bit/IE/indication/information to indicate that whether the UE 502 is only allowed as a normal UE/UE (No MBSR)/UE (without mobile relay operation) or whether the UE is also allowed as UE (with mobile relay operation)/UE (MBSR), optionally in/per any given area/PLMN/Geographical location. The UE(s) 502 may even be pre-configured or provisioned in the ME/USIM indicating that whether the UE 502 is allowed as a normal UE/UE (No MBSR)/UE (without mobile relay operation) or whether the UE is also allowed as UE (with mobile relay operation)/UE (MBSR), optionally per/in an area/PLMN/Geographical location. The bit/IE may, optionally, be a 1-bit flag; for example, “Mobile Relay Operation allowed” and can be defined as below:
Bit value is 0, which means/indicates that the UE 502 is not allowed to act/behave as a UE 502 with Mobile Relay Operation. The UE 502 shall perform registration/register with the Network as a normal UE (i.e., No MBSR/without Mobile Relay operation). The UE 502 may not indicate its support/capability/intention for MBSR or IAB or Mobile Relay to the Network/Network Function.
Bit value is 1, which means/indicates that the UE 502 is allowed to act/behave as a UE 502 with Mobile Relay Operation. The UE 502 may perform registration/register with the Network as a UE (MBSR) (i.e., with MBSR capability/with Mobile Relay operation). The UE 502 may indicate its support for MBSR or IAB or Mobile Relay to the Network/Network Function/entity 501.

In an embodiment herein, the above indication/bit/IE may optionally be applied in/per given area/PLMN/geographical location. When the UE 502 determines that the bit/IE value is set or changed, the UE 502 shall store/update the bit value stored in the UE (USIM/ME) (if already available) and selectively perform the registration procedure based on the value of the bit/IE. In an embodiment herein, the flag is “Mobile Relay Operation allowed”. If the flag is not configured by the HPLMN (or the EHPLMN) or the serving/registered PLMN or any PLMN in any of the UE's preferred lists (for example, EHPLMN List, OPLMN list, UPLMN list etc.) in the UE 502, then the UE 502 determines its value as 0.

If the flag is not configured by the HPLMN (or the EHPLMN) or the serving/registered PLMN or any PLMN in any of the UE's preferred lists (for example, EHPLMN List, OPLMN list, UPLMN list etc.) in the UE 502, then the UE 502 determines its value as 1. If the flag is not stored or maintained in the UE 502 (either in ME or in the USIM), then the UE 502 determines its value as 0. If the flag is not stored or maintained in the UE 502 (either in ME or in the USIM), then the UE 502 determines its value as 1. This flag is stored in the UE 502 after switching OFF and switching ON i.e., power cycle or reboot. In an embodiment herein, the flag is removed from the UE 502 after switching OFF and switching ON i.e., power cycle or reboot. The flag can be maintained by the UE 502 till a new USIM is inserted in the UE 502. This flag can be cleared or removed by the UE 502 if the USIM is removed and re-inserted. This flag can be stored or maintained by the UE 502 if the USIM is removed and re-inserted.

The UE 502 may also be pre-configured/provisioned in the ME/USIM or Home Operator or the Home PLMN (HPLMN)/EHPLMN or the serving/registered PLMN or any PLMN in any of the UE's preferred lists (for example, EHPLMN List, OPLMN list, UPLMN list etc.) may configure separate preferred PLMN(s) lists, one “Preferred PLMN(s) List for UE” which is for the UE 502 to use when the UE 502 is allowed to operate only as normal UE (no MBSR) and there may be one other “Preferred PLMN(s) List for MBSR” which is for the UE 502 to use when the UE 502 is allowed to operate as a MBSR/Mobile Relay operation. The UE 502 may optionally, only be configured/pre-configured/provisioned with preferred PLMN(s) List for the UE 502 to use when the UE 502 is allowed to operate as a MBSR/Mobile Relay operation.

The above preferred PLMN(s) list may, optionally, be given and applicable/valid in/per given area/PLMN/geographical location. The preferred PLMN(s) list for a MBSR UE 502 may also be configured/pre-configured in the UE 502 separately while the UE 502 may still use/follow the preference order of the PLMN(s) from any of the preferred PLMN List from “PLMN selection as per 23.122 without RPLMN” or “PLMN selection as per 23.122 with RPLMN” when the UE 502 behaves as a normal UE. So, there may be two preferred PLMN lists in a UE 502 as below:
1. A preferred PLMN list for MBSR, to be used when the UE 502 is operating as MBSR in any area. The preferred PLMN list for the MBSR contains the list of PLMN/access technology combinations, in priority order (highest to lowest), which the UE 502 may prefer to select and attempt registration for mobile relay operations. In an embodiment herein, the preferred PLMN list is provided to the UE 502 in the priority order consisting of one of the list of PLMNs, PLMN/access technology combinations, PLMN selection as per 23.122 without RPLMN” and “PLMN selection as per 23.122 with RPLMN”.
2. Optionally, the preferred PLMN list for a normal UE (may be similar or same as from “PLMN selection as per 23.122 without RPLMN” or “PLMN selection as per 23.122 with RPLMN”), to be used when the UE 502 is operating as a normal UE; i.e., when the UE is not behaving as a MBSR in any area.

When the UE(s) is pre-configured or provisioned in the ME/USIM or configured by the HPLMN or the EHPLMN or the serving/registered PLMN or any PLMN in any of the UE's preferred lists (for example, EHPLMN List, OPLMN list, UPLMN list etc.) indicating bit/IE “Mobile Relay Operation allowed” is set to value 0, i.e., the UE 502 is allowed as only a normal UE (no MBSR) in an area, then the UE 502 may perform the PLMN selection procedure as per “PLMN selection as per 23.122 without RPLMN” or “PLMN selection as per 23.122 with RPLMN”.

The UE 502 may follow any of the below order, in any possible combination(s), for PLMN selection and attempt registration:
1A. When the UE(s) 502 is pre-configured or provisioned in the ME/USIM or configured by the HPLMN or the EHPLMN or the serving/registered PLMN or any PLMN in any of the UE's preferred lists (for example, EHPLMN List, OPLMN list, UPLMN list etc.) indicating bit/IE “Mobile Relay Operation allowed” is set to value 1, i.e., UE 502 is allowed as MBSR in an area, then the UE 502 selects and attempts registration on other PLMN/access technology combinations, if available and allowable, for mobile relay operations only or normal services along with mobile relay operations, in the following order:
   each PLMN/access technology combination in the “Preferred PLMN list for MBSR”, if present, (in priority order);
   each PLMN/access technology combination in the “Preferred PLMN list for Normal UE”, if present, (in priority order). The Preferred PLMN list for a normal UE may be similar or same as from “PLMN selection as per 23.122 without RPLMN” or “PLMN selection as per 23.122 with RPLMN”;
   other PLMN/access technology combinations with received high quality signal in random order; and
   other PLMN/access technology combinations in order of decreasing signal quality.
1B. In an embodiment herein, when the UE(s) 502 is pre-configured or provisioned in the ME/USIM or configured by the HPLMN or the EHPLMN or the serving/registered PLMN or any PLMN in any of the UE's preferred lists (for example, EHPLMN List, OPLMN list, UPLMN list etc.) indicating bit/IE “Mobile Relay Operation allowed” is set to value 1, i.e., MBSR is allowed as MBSR in an area, then the UE 502 selects and attempts registration on other PLMN/access technology combinations, if available and allowable, for mobile relay operations only or normal services along with mobile relay operations, in the following order:
   each PLMN/access technology combination in the “Preferred PLMN list for Normal UE”, if present, (in priority order). The Preferred PLMN list for a normal UE may be similar or same as from “PLMN selection as per 23.122 without RPLMN” or “PLMN selection as per 23.122 with RPLMN”;
   each PLMN/access technology combination in the “Preferred PLMN list for MBSR”, if present, (in priority order);
   other PLMN/access technology combinations with received high quality signal in random order; and
   other PLMN/access technology combinations in order of decreasing signal quality.
1C. In an embodiment herein, when the UE(s) 502 is pre-configured or provisioned in the ME/USIM or configured by the HPLMN or the EHPLMN or the serving/registered PLMN or any PLMN in any of the UE's preferred lists (for example, EHPLMN List, OPLMN list, UPLMN list etc.) indicating bit/IE “Mobile Relay Operation allowed” is set to value 1, i.e. MBSR is allowed as MBSR in an area, then the UE 502 selects and attempts registration on other PLMN/access technology combinations, if available and allowable, for mobile relay operations only or normal services along with mobile relay operations, in the following order:
   each PLMN/access technology combination in the “Preferred PLMN list for MBSR”, if present, (in priority order);
   other PLMN/access technology combinations with received high quality signal in random order; and
   other PLMN/access technology combinations in order of decreasing signal quality.
1D. In an embodiment herein, when the UE(s) 502 is pre-configured or provisioned in the ME/USIM or configured by the HPLMN or the EHPLMN or the serving/registered PLMN or any PLMN in any of the UE's 502 preferred lists (for example, EHPLMN List, OPLMN list, UPLMN list etc.) indicating bit/IE “Mobile Relay Operation allowed” is set to value 1, i.e., MBSR is allowed as MBSR in an area, then the UE 502 selects and attempts registration on other PLMN/access technology combinations, if available and allowable, for mobile relay operations only or normal services along with mobile relay operations, in any random order.

The UE 502 may select any of the operations 1A, 1B, 1C, 1D in any possible combination or in any order.

The UE 502 may follow any of the below order, in any possible combination(s), for PLMN selection and to attempt registration:
2A. In an embodiment herein, when the UE(s) 502 is pre-configured or provisioned in the ME/USIM or configured by the HPLMN or the EHPLMN or the serving/registered PLMN or any PLMN in any of the UE's preferred lists (for example, EHPLMN List, OPLMN list, UPLMN list, random PLMNs not configured in the list etc.) indicating bit/IE “Mobile Relay Operation allowed” is set to value 1, i.e. MBSR is allowed as MBSR in an area, then UE 502 selects and attempts registration on other PLMN/access technology combinations, if available and allowable, for normal services only (for example, not indicating support for MBSR or not getting services as a UE (MBSR)), in the following order:
   each PLMN/access technology combination in the “Preferred PLMN list for Normal UE”, if present, (in priority order). The Preferred PLMN list for a normal UE may be similar or same as from “PLMN selection as per 23.122 without RPLMN” or “PLMN selection as per 23.122 with RPLMN”;
   each PLMN/access technology combination in the “Preferred PLMN list for MBSR”, if present, (in priority order);
   other PLMN/access technology combinations with received high quality signal in random order; and
   other PLMN/access technology combinations in order of decreasing signal quality.
2B. In an embodiment herein, when the UE(s) 502 is pre-configured or provisioned in the ME/USIM or configured by the HPLMN or the EHPLMN or the serving/registered PLMN or any PLMN in any of the UE's preferred lists (for example, EHPLMN List, OPLMN list, UPLMN list etc.) indicating bit/IE “Mobile Relay Operation allowed” is set to value 1, i.e. MBSR is allowed as MBSR in an area, then the UE 502 selects and attempts registration on other PLMN/access technology combinations, if available and allowable, for normal services only (for example, not indicating support for MBSR or not getting services as a UE (MBSR)), in the following order:
   each PLMN/access technology combination in the “Preferred PLMN list for Normal UE”, if present, (in priority order). The Preferred PLMN list for a normal UE may be similar or same as from “PLMN selection as per 23.122 without RPLMN” or “PLMN selection as per 23.122 with RPLMN”;
   other PLMN/access technology combinations with received high quality signal in random order; and
   other PLMN/access technology combinations in order of decreasing signal quality.
2C. In an embodiment herein, when the UE(s) 502 is pre-configured or provisioned in the ME/USIM or configured by the HPLMN or the EHPLMN or the serving/registered PLMN or any PLMN in any of the UE's preferred lists (for example, EHPLMN List, OPLMN list, UPLMN list etc.) indicating bit/IE “Mobile Relay Operation allowed” is set to value 1, i.e. MBSR is allowed as MBSR in an area, then the UE 502 selects and attempts registration on other PLMN/access technology combinations, if available and allowable, for normal services only (for example, not indicating support for MBSR or not getting services as a UE (MBSR)), in any random order.

The UE may select any of the above operations 2A, 2B, 2C in any possible combination or in any order.

List as referred to herein can be either of “Preferred PLMN(s) List for MBSR” or “Preferred PLMN(s) List for UE”. In an embodiment herein, if the list is not configured by the HPLMN (or the EHPLMN) or the serving/registered PLMN or any PLMN in any of the UE's preferred lists (for example, EHPLMN List, OPLMN list, UPLMN list etc.) in the UE 502, then the UE 502 determines that the list is not present, or the list is empty. In an embodiment herein, if the list is not stored or maintained in the UE 502 (either in ME or in the USIM), then the UE 502 determines that the list is not present, or the list is empty. In an embodiment herein, if the list is not stored or maintained in the UE 502 (either in ME or in the USIM), then the UE 502 shall create a list with zero entries. In an embodiment herein, this list is stored in the ME after switching off and switching ON i.e., power cycle or reboot. In an embodiment herein, the list is removed/deleted from the ME after switching off and switching ON, i.e., power cycle or reboot. The list is maintained by the UE 502 till a new USIM is inserted in the UE 502. In an embodiment herein, this list is cleared or deleted by the UE 502 if the USIM is removed and re-inserted. In an embodiment herein, this list is stored or maintained by the UE 502 if the USIM is removed and re-inserted.

The UE 502 may be pre-configured/provisioned in the ME/USIM or the Home Operator or the Home PLMN (HPLMN)/EHPLMN or the serving/registered PLMN or any PLMN in any of the UE's preferred lists (for example, EHPLMN List, OPLMN list, UPLMN list etc.) may configure separate FORBIDDEN PLMN(s) lists, i.e., one “Forbidden PLMN List for MBSR” which contains the list of PLMN/access technology combinations on which the UE 502 is not allowed to/UE 502 shall not attempt registration for Mobile relay operations and another “Forbidden PLMN List for UE” which contains the list of PLMN/access technology combinations on which the UE 502 is not allowed to/UE 502 shall not attempt registration for normal services. The forbidden PLMN List(s) may optionally be applied in/per given area/PLMN/geographical location. So, there may be two separate Forbidden PLMN (FPLMN) lists in the UE 502 as below:
“Forbidden PLMN (FPLMN) list for MBSR”, to be used when the UE 502 is operating as MBSR in any area. The UE 502 shall not select and attempt registration on any of the PLMN(s), present in the Forbidden PLMN (FPLMN) list for MBSR, for mobile relay operations only or for normal services along with mobile relay operations; for example, the UE 502 will behave as a normal UE 502 and not as MBSR UE. The UE 502 may not indicate its support of MBSR to network function. The UE 502 may still select and attempt registration on these PLMN(s) for normal services, if these PLMN(s) are not present in the Forbidden PLMN (FPLMN) list for the UE 502.
“Forbidden PLMN (FPLMN) list for UE”, to be used when the UE 502 is operating as Normal UE (no-MBSR/without mobile relay operation) in any area. The UE 502 shall not select and attempt registration on any of the PLMN(s), present in the Forbidden PLMN (FPLMN) list for the UE 502, for normal services. Further, the UE 502 shall not select and attempt registration on these PLMN(s) for mobile relay operations.

The UE 502 shall not select and shall not try to camp/shall not attempt to camp/shall not perform registration or mobility registration update or PLMN Selection on any PLMN/access technology combinations or in the geographical area (e.g. TAI, cell), which is/are present in “Forbidden PLMN (FPLMN) list for MBSR (also can be called as Forbidden geographical area list for MBSR), if present in the UE (ME/USIM), for mobile relay operations or for normal services along with mobile relay operations. The UE 502 shall remove or delete any PLMN/access technology combinations, geographical area information like TAI, cell, from the “Forbidden PLMN (FPLMN) list for MBSR” also can be called as Forbidden geographical area list for MBSR), if present in the UE 502 (ME/USIM), whenever the UE 502 is successfully registered on that PLMN/access technology combinations for mobile relay operations or for normal services along with mobile relay operations. The UE 502 may optionally remove/delete/update the area/PLMN/TAI/geographical location along-with the entry of the PLMN/Access Technology combinations in the “Forbidden PLMN (FPLMN) list for MBSR”, if the area/PLMN/TAI/geographical location is indicated by the network entity 501, where the UE 502 is allowed to register for mobile relay operations or for normal services along with mobile relay operations. The UE 502 shall add/update any PLMN/access technology combinations in/to the “Forbidden PLMN (FPLMN) list for MBSR”, if present in the UE (ME/USIM), whenever the UE 502 gets a reject message with an appropriate cause or an indication in any of the AS/NAS signaling message on/from the selected PLMN/access technology combinations/Network indicating that the UE 502 is not allowed to register on the selected PLMN/Access Technology combinations for mobile relay operations or for normal services along with mobile relay operations. The UE 502 may optionally store/update the area/PLMN/TAI/geographical location along-with the entry of the PLMN/Access Technology combinations in the “Forbidden PLMN (FPLMN) list for MBSR”, optionally the area/PLMN/TAI/geographical location is explicitly indicated by the network entity 501 where the UE 502 is not allowed to register for mobile relay operations or for normal services along with mobile relay operations or implicitly the UE 502 understands that the area/PLMN/TAI/geographical location is not allowed to operate as a MBSR with the appropriate reject cause. If the “Forbidden PLMN (FPLMN) list for MBSR” is not present in the UE (ME/USIM), the UE 502 shall create a “Forbidden PLMN (FPLMN) list for MBSR” in the ME/USIM and add/store/update the PLMN/Access technology combinations and optionally the geographical area/PLMN etc., as indicated by the network entity 501.

The UE 502 maintains the list of Forbidden geographical area (for example, TAI, Cell) list for MBSR where the UE 502 will not act as MBSR UE. The UE 502 updates this list each time network indicates in a NAS/AS signaling message; for example, registration reject, registration accept, service reject or service accept with an appropriate cause, new IE etc. When UE moves out of such determined forbidden area, the UE determines it can act as MBSR and indicates its intention/capability to act as MBSR to network (NG-RAN/AMF).

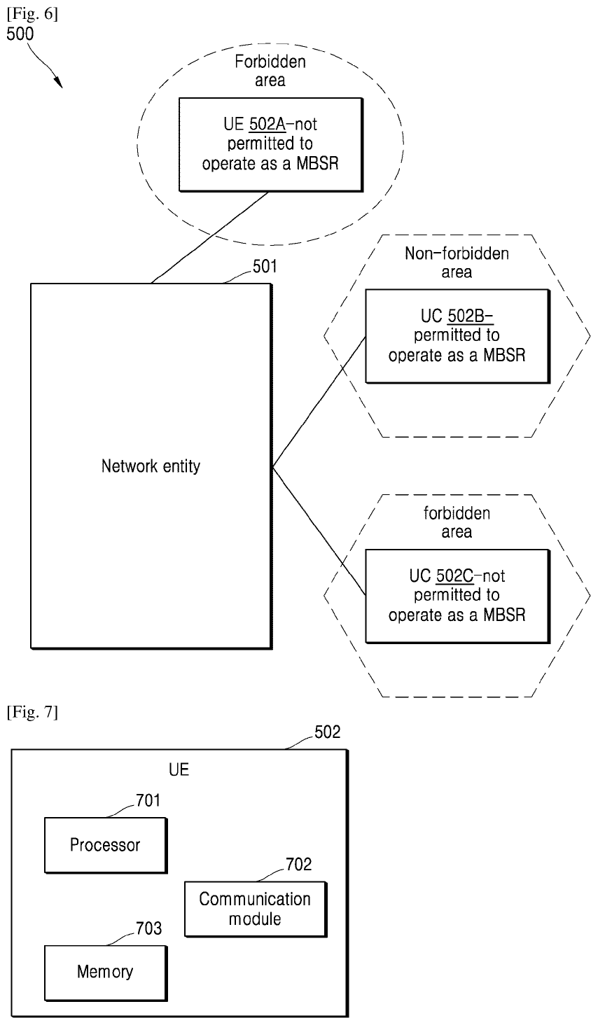

FIG. 6 depicts an example scenario, wherein one or more UEs 502 are connected to the network entity 501. In the depicted example scenario, a first UE 502A and a third UE 502C are located in forbidden areas; i.e., they are not allowed to act as a MBSR. A second UE 502B is located in a non-forbidden area; i.e., the UE 502B is allowed to operate as a MBSR.

FIG. 7 shows various hardware components of the UE 502, according to the embodiments as disclosed herein. In an embodiment, the UE 502 includes a processor 701, a communication module 702, and a memory 703. The processor 701 can be coupled with the communication 702, and the memory 703.

The processor 701 can be implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor 701 can be configured to execute instructions stored in the memory 703 and to perform various processes. The communication module 702 configured for communicating internally between internal hardware components and with external devices via one or more networks. The memory 703 can also store instructions to be executed by the processor 701. The memory 703 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 703 may, in some examples, be considered a non-transitory storage medium. The term “non-transitory” may indicate that the storage medium is not embodied in a carrier wave or a propagated signal. However, the term “non-transitory” should not be interpreted that the memory 703 is non-movable. In certain examples, a non-transitory storage medium may store data that can, over time, change (e.g., in Random Access Memory (RAM) or cache).

When a NAS reject message is received from the network entity (such as, but not limited to, an AMF) with appropriate cause value optionally, if the area is not included, the processor 701 can determine implicitly without an explicit indication from the network entity that the UE 502 is not allowed to operate in the current TAI/cell/area/geographical location/PLMN. The processor 701 can ensure that the UE 502 remains registered with the network entity in response to determining that the UE 502 can operate as MBSR, and the current camped area is not a forbidden area. On determining that the UE is not allowed to operate as MBSR and optionally, the current area is a forbidden area, the processor 701 can perform at least one of the trigger registration procedure and indicate no support or no intention of acting as MBSR to the network; i.e., to not operate as a MBSR. The processor 701 can make the UE 502 enter a limited service state or PLMN search state, and perform a PLMN selection procedure. The processor 701 maintains the list of TAIs where it is forbidden to act as a MBSR and in those respective TAIs, the UE 502 will cease to act as a MBSR. On the UE moving out of the forbidden TAIs, the processor 701 will trigger a registration procedure to act as a MBSR.

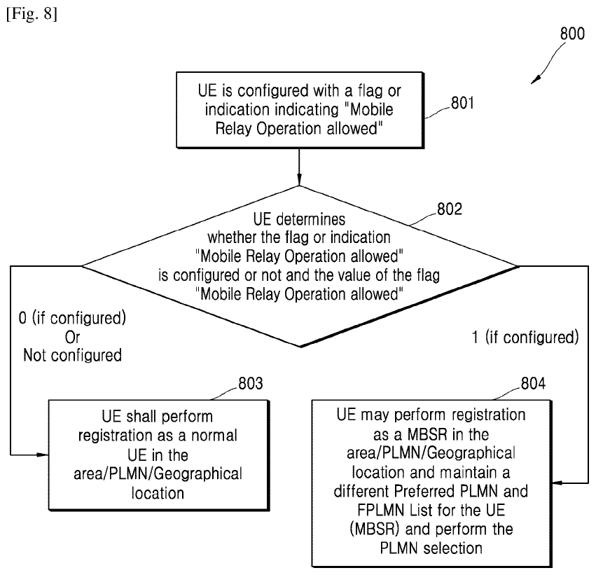

FIG. 8 depicts a process for the HPLMN/EHPLMN or the serving/registered PLMN or any PLMN in any of UE's preferred lists to selectively control the UE behaviour to either act as a normal UE or as a UE (MBSR). In step 801, the UE 502 is configured with a flag or indication indicating “Mobile Relay Operation allowed” by the HPLMN or the EHPLMN in the Registration Accept message or using the UE Parameters Update (UPU) procedure or through any of AS/NAS signalling or in (5GS) Network Feature support. In step 802, the UE 502 determines whether the flag or indication “Mobile Relay Operation allowed” is configured or not and what is the value of the flag “Mobile Relay Operation allowed”. If the value of the flag is 0 (if configured) or if the value of the flag is not configured and the applicable area, in step 803, the UE 502 shall perform registration as a normal UE (i.e. no MBSR in the area/PLMN/Geographical location). If the value of the flag 1, in step 804, the UE 502 shall perform registration as a MBSR in the area/PLMN/Geographical location. Also, the UE 502 may maintain a different Preferred PLMN and FPLMN List for the UE (MBSR) and perform the PLMN selection. The various actions in method 800 may be performed in the order presented, in a different order or simultaneously. Further, in some embodiments, some actions listed in FIG. 8 may be omitted.

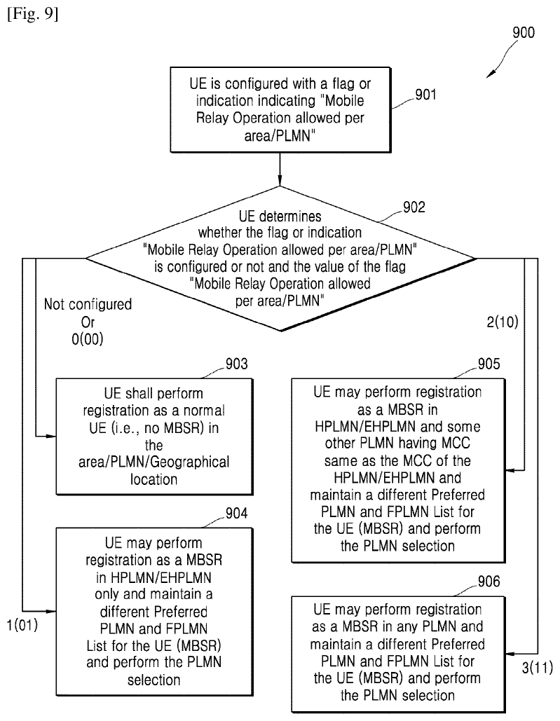

FIG. 9 depicts a method for the HPLMN or the EHPLMN or the serving/registered PLMN or any PLMN in any of the UE's preferred lists (for example, EHPLMN List, OPLMN list, UPLMN list etc.) to control/prioritize/restrict certain PLMN(s) for UE, to operate as UE (MBSR), over other PLMN(s). In step 901, the UE(s) 502 shall be configured by the Home Operator or the Home PLMN (HPLMN)/EHPLMN or the serving/registered PLMN or any PLMN in any of the UE's preferred lists (for example, EHPLMN List, OPLMN list, UPLMN list etc.) in a AS/NAS signalling message; for example, Registration Accept message, UE Configuration Update (UCU) Command/message, UE Parameters Update (UPU) Command/message etc.), optionally using any bit/IE/indication/information indicating that whether the UE is only allowed as a normal UE/UE (No MBSR)/UE (without mobile relay operation) or whether the UE is also allowed as UE (with mobile relay operation)/UE (MBSR), optionally in/per any given area/PLMN/Geographical location (step 902). The UE(s) 502 may even be preconfigured or provisioned in the ME/USIM indicating that whether the UE 502 is allowed to operate as a normal UE/UE (No MBSR)/UE (without mobile relay operation) or whether the UE is also allowed as UE (with mobile relay operation)/UE (MBSR), per/in an area/PLMN/Geographical location. In an embodiment herein, the bit/IE can be a 2-bit flag; for example-“Mobile Relay Operation allowed per area/PLMN” and can be defined as below:
Bit value is 00 (step 903), which means/indicates the UE is not allowed to act/behave as a UE 502 with Mobile Relay Operation in any area/PLMN/Geographical location. The UE 502 shall perform registration/register with the Network as a normal UE 502 (i.e., no MBSR/without Mobile Relay operation). The UE 502 may not indicate its support for MBSR or IAB or Mobile Relay to the Network/Network entity 501.
Bit value is 01 (step 904), which means which means/indicates the UE 502 is allowed to act/behave as a UE 502 with Mobile Relay Operation in HPLMN/EHPLMN only. The UE 502 may perform registration/register with the Network as a UE (MBSR) (i.e., with MBSR capability/with Mobile Relay operation) or the UE 502 may indicate its support for MBSR or IAB or Mobile Relay to the Network/Network entity 501 when the serving network is the HPLMN/EHPLMN of the UE 502.
Bit value is 10 (step 905), which means which means/indicates the UE 502 is allowed to act/behave as a UE 502 with Mobile Relay Operation in HPLMN/EHPLMN and some other PLMN having MCC the same as the MCC of the HPLMN/EHPLMN (for e.g., the UE 502 is in the same country of the HPLMN/EHPLMN). The UE 502 may perform registration/register with the Network as a UE (MBSR) (i.e., with MBSR capability/with Mobile Relay operation) or the UE 502 may not indicate its support for MBSR or IAB or Mobile Relay to the Network/Network Function when the serving network is the HPLMN/EHPLMN of the UE 502 or any other PLMN having MCC same as the MCC of the HPLMN/EHPLMN.
Bit value is 11 (step 906), which means/indicates the UE 502 is allowed to act/behave as a UE 502 with Mobile Relay Operation in any PLMN in any area/PLMN/Geographical location. The UE 502 may perform registration/register with the Network as a UE (MBSR) (i.e., with MBSR capability/with Mobile Relay operation) or the UE 502 may not indicate its support for MBSR or IAB or Mobile Relay to the Network/Network Function.

When the UE 502 determines that the bit/IE value is set or changed, the UE 502 shall store/update the bit value stored in the UE 502 (USIM/ME) (if already available) and selectively perform the registration procedure based on the value of the bit/IE.

In an embodiment herein, the flag can be a “Mobile Relay Operation allowed per area/PLMN”. In an embodiment herein, if the flag is not configured by the HPLMN (or the EHPLMN) in the UE 502, then the UE 502 determines its value as 00. In an embodiment herein, if the flag is not configured by the HPLMN (or the EHPLMN) in the UE 502, then the UE 502 determines its value as 01. In an embodiment herein, if the flag is not configured by the HPLMN (or the EHPLMN) in the UE 502, then the UE 502 determines its value as 10. In an embodiment herein, if the flag is not configured by the HPLMN (or the EHPLMN) in the UE 502, then the UE 502 determines its value as 11. In an embodiment herein, if the flag is not stored or maintained in the UE 502 (either in ME or in the USIM), then the UE 502 determines its value as 00. In an embodiment herein, if the flag is not stored or maintained in the UE 502 (either in ME or in the USIM), then the UE 502 determines its value as 01. In an embodiment herein, if the flag is not stored or maintained in the UE 502 (either in ME or in the USIM), then the UE 502 determines its value as 10. In an embodiment herein, if the flag is not stored or maintained in the UE 502 (either in ME or in the USIM), then the UE 502 determines its value as 11. In an embodiment herein, this flag can be stored in the ME after switching off and switching ON; i.e., power cycle or reboot. In an embodiment herein, the flag is removed from the ME after switching off and switching ON; i.e., power cycle or reboot. The flag can be maintained by the UE 502 till a new USIM is inserted in the UE 502. In an embodiment herein, this flag can be cleared or removed by the UE 502 if the USIM is removed and re-inserted. In an embodiment herein, this flag can be stored or maintained by the UE 502 if the USIM is removed and reinserted.

The UE 502 may also be pre-configured/provisioned in the ME/USIM or Home Operator or the Home PLMN (HPLMN)/EHPLMN or the serving/registered PLMN or any PLMN in any of the UE's preferred lists (for example, EHPLMN List, OPLMN list, UPLMN list etc.) may configure separate preferred PLMN(s) lists, one “Preferred PLMN(s) List for UE” which is for the UE 502 to use when the UE is allowed to operate only as normal UE (No MBSR) and there may be one other “Preferred PLMN(s) List for MBSR” which is for the UE 502 to use when the UE 502 is allowed to operate as a MBSR/Mobile Relay operation. The UE 502 may, optionally, only be configured/pre-configured/provisioned with preferred PLMN(s) List for the UE 502 to use, when the UE 502 is allowed to operate as a MBSR/Mobile Relay operation. The preferred PLMN(s) List may, optionally, be given and applicable/valid in/per given area/PLMN/geographical location. The preferred PLMN(s) list for MBSR UE 502 may also be configured/pre-configured in the UE 502 separately, while the UE 502 may still use/follow the preference order of the PLMN(s) from any of the preferred PLMN List from “PLMN selection as per 23.122 without RPLMN” or “PLMN selection as per 23.122 with RPLMN” when the UE 502 behaves as a normal UE 502. So, there may be two preferred PLMN lists in a UE 502 as below:
Preferred PLMN list for MBSR, to be used when the UE 502 is operating as MBSR in any area. The Preferred PLMN List for MBSR contains the list of PLMN/access technology combinations, in priority order (highest to lowest), which the UE 502 may prefer to select and attempt registration for Mobile relay operations. The preferred PLMN list is provided to the UE 502 in the priority order comprising of one of the list of PLMNs, PLMN/access technology combinations, PLMN selection as per 23.122 without RPLMN” and “PLMN selection as per 23.122 with RPLMN”.
Optionally, the preferred PLMN list for a normal UE (may be similar or same as from “PLMN selection as per 23.122 without RPLMN” or “PLMN selection as per 23.122 with RPLMN”), to be used when the UE 502 is operating as a normal UE; i.e., when the UE 502 is not behaving as a MBSR in any area.

When the UE(s) 502 is pre-configured or provisioned in the ME/USIM or configured by the HPLMN or the EHPLMN or the serving/registered PLMN or any PLMN in any of the UE's preferred lists (for example, EHPLMN List, OPLMN list, UPLMN list etc.) indicating bit/IE “Mobile Relay Operation allowed per area/PLMN” is set to value 00, i.e., the UE 502 is allowed as only a normal UE (No MBSR) in an area, then the UE 502 may perform the PLMN selection procedure as per “PLMN selection as per 23.122 without RPLMN” or “PLMN selection as per 23.122 with RPLMN”.

The UE 502 may follow any of the below order, in any possible combination(s), for PLMN selection and to attempt registration:
3A. When the UE(s) is pre-configured or provisioned in the ME/USIM or configured by the HPLMN indicating bit/IE “Mobile Relay Operation allowed per area/PLMN” is set to value 01, i.e., the UE 502 is allowed to act/behave as a UE 502 with Mobile Relay Operation in HPLMN/EHPLMN only, then the UE 502 selects and attempts registration on other PLMN/access technology combinations, if available and allowable, for mobile relay operations or normal services along with mobile relay operations, in the following order:
   either the HPLMN (if the EHPLMN list is not present or is empty) or the highest priority EHPLMN that is available (if the EHPLMN list is present) in the “Preferred PLMN list for MBSR”, if present, (in priority order);
   either the HPLMN (if the EHPLMN list is not present or is empty) or the highest priority EHPLMN that is available (if the EHPLMN list is present); and
   Any of the above in random order.
3B. In an embodiment herein, when the UE(s) is pre-configured or provisioned in the ME/USIM or configured by the HPLMN indicating bit/IE “Mobile Relay Operation allowed per area/PLMN” is set to value 10, i.e. the UE 502 is allowed to act/behave as a UE 502 with Mobile Relay Operation in HPLMN/EHPLMN and some other PLMN having MCC same as the MCC of the HPLMN/EHPLMN, then the UE 502 selects and attempts registration on other PLMN/access technology combinations, if available and allowable, for mobile relay operations or normal services along with mobile relay operations, in the following order:
   Either the HPLMN/EHPLMN or any PLMN/Access Technology combinations having MCC same as the MCC of the HPLMN/EHPLMN of the UE 502 present in the “Preferred PLMN list for MBSR”, if present, (in priority order);
   Either the HPLMN/EHPLMN or any PLMN/Access Technology combinations having MCC same as the MCC of the HPLMN/EHPLMN of the UE 502 present in the “Preferred PLMN list for Normal UE”, if present, (in priority order). The Preferred PLMN list for a normal UE 502 may be similar or same as from “PLMN selection as per 23.122 without RPLMN” or “PLMN selection as per 23.122 with RPLMN”;
   Either the HPLMN/EHPLMN or other PLMN/access technology combinations having MCC same as the MCC of the HPLMN/EHPLMN of the UE 502 with received high quality signal in random order;
   Either the HPLMN/EHPLMN or other PLMN/access technology combinations having MCC same as the MCC of the HPLMN/EHPLMN of the UE in order of decreasing signal quality; and
   Any of the above can be in random order.
3C. In an embodiment herein, when the UE(s) is pre-configured or provisioned in the ME/USIM or configured by the HPLMN indicating bit/IE “Mobile Relay Operation allowed per area/PLMN” is set to value 11, i.e., the UE 502 is allowed to act/behave as a UE with Mobile Relay Operation in any PLMN in any area/PLMN/Geographical location, then the UE 502 selects and attempts registration on other PLMN/access technology combinations, if available and allowable, for mobile relay operations or normal services along with mobile relay operations, in the following order:
   each PLMN/access technology combination in the “Preferred PLMN list for MBSR”, if present, (in priority order);
   each PLMN/access technology combination in the “Preferred PLMN list for Normal UE”, if present, (in priority order). The Preferred PLMN list for a normal UE may be similar or same as from “PLMN selection as per 23.122 without RPLMN” or “PLMN selection as per 23.122 with RPLMN”;
   other PLMN/access technology combinations with received high quality signal in random order;
   other PLMN/access technology combinations in order of decreasing signal quality; and
   Any of the above can be in random order.

The UE may select any of the operations 3A, 3B, and 3C in any possible combination or in any order.

List as referred to herein can be either of “Preferred PLMN(s) List for MBSR” or “Preferred PLMN(s) List for UE”. In an embodiment herein, if the list is not configured by the HPLMN (or the EHPLMN) in the UE, then the UE determines that the list is not present, or the list is empty. In an embodiment herein, if the list is not stored or maintained in the UE 502 (either in ME or in the USIM), then the UE 502 determines that the list is not present, or the list is empty. In an embodiment herein, if the list is not stored or maintained in the UE 502 (either in ME or in the USIM), then the UE 502 shall create a list with zero entries. In an embodiment herein, this list can be stored in the ME after switching off and switching ON; i.e., power cycle or reboot. In an embodiment, the list is removed/deleted from the ME after switching off and switching ON i.e., power cycle or reboot. The list can be maintained by the UE 502 till a new USIM is inserted in the UE 502. In an embodiment herein, this list can be cleared or deleted by the UE 502, if the USIM is removed and re-inserted. In an embodiment herein, this list can be stored or maintained by the UE 502, if the USIM is removed and re-inserted.

The UE 502 may be pre-configured/provisioned in the ME/USIM or the Home Operator or the Home PLMN (HPLMN)/EHPLMN may configure separate FORBIDDEN PLMN(s) lists, i.e., one “Forbidden PLMN List for MBSR” which contains the list of PLMN/access technology combinations on which the UE 502 is not allowed to/UE 502 shall not attempt registration for Mobile relay operations and another “Forbidden PLMN List for UE” which contains the list of PLMN/access technology combinations on which the UE 502 is not allowed to/UE shall not attempt registration for normal services. The above forbidden PLMN List(s) may optionally be applied in/per given area/PLMN/geographical location/TAI/cell. So, there may be two separate Forbidden PLMN (FPLMN) lists in a UE 502 as below:
“Forbidden PLMN (FPLMN) list for MBSR”, to be used optionally when the UE is operating as MBSR in any area. The UE 502 shall not select and attempt registration on any of the PLMN(s)/area, present in the Forbidden PLMN (FPLMN) list for MBSR, for mobile relay operations or for normal services along with mobile relay operations (for example, the UE 502 will behave as a normal UE and not as MBSR UE). The UE 502 may not indicate its support of MBSR to the network function. The UE 502 may still select and attempt registration on these PLMN(s) for normal services, if these PLMN(s) are not present in the Forbidden PLMN (FPLMN) list for the UE 502.
“Forbidden PLMN (FPLMN) list for UE”, to be used when the UE 502 is operating as Normal UE (no-MBSR/without mobile relay operation) in any area. The UE 502 shall not select and attempt registration on any of the PLMN(s), present in the Forbidden PLMN (FPLMN) list for the UE 502, for normal services. Further, the UE 502 shall not select and attempt registration on these PLMN(s) for mobile relay operations.

The UE 502 shall not select and shall not try to camp/shall not attempt to camp/shall not perform registration or mobility registration update or PLMN Selection on any PLMN/access technology combinations, which is/are present in “Forbidden PLMN (FPLMN) list for MBSR, if present in the UE (ME/USIM), for mobile relay operations or for normal services along with mobile relay operations. The UE 502 shall remove or delete any PLMN/access technology combinations, from the “Forbidden PLMN (FPLMN) list for MBSR”, if present in the UE (ME/USIM), whenever the UE 502 is successfully registered on that PLMN/access technology combinations for mobile relay operations or for normal services along with mobile relay operations. The UE 502 may optionally remove/delete/update the area/PLMN/TAI/geographical location along with the entry of the PLMN/Access Technology combinations in the “Forbidden PLMN (FPLMN) list for MBSR”, if the area/PLMN/TAI/geographical location is indicated by the Network, where the UE 502 is allowed to register for mobile relay operations or for normal services along with mobile relay operations. The UE 502 shall add/update any PLMN/access technology combinations in/to the “Forbidden PLMN (FPLMN) list for MBSR”, if present in the UE (ME/USIM), whenever the UE 502 gets a reject or an indication in any of the AS/NAS signaling message on/from the selected PLMN/access technology combinations/Network indicating that the UE 502 is not allowed to register on the selected PLMN/Access Technology combinations for mobile relay operations or for normal services along with mobile relay operations. The UE 502 may optionally store/update the area/PLMN/TAI/geographical location along-with the entry of the PLMN/Access Technology combinations in the “Forbidden PLMN (FPLMN) list for MBSR” if the area/PLMN/TAI/geographical location is indicated by the Network, where the UE 502 is not allowed to register for mobile relay operations or for normal services along with mobile relay operations. If the “Forbidden PLMN (FPLMN) list for MBSR” is not present in the UE (ME/USIM), the UE 502 shall create a “Forbidden PLMN (FPLMN) list for MBSR” in the ME/USIM and add/store/update the PLMN/Access technology combinations and optionally the geographical area/PLMN etc., as indicated by the network entity 501.

List as referred to herein can be either of “Forbidden PLMN (FPLMN) list for MBSR” or “Forbidden PLMN (FPLMN) list for UE”. In an embodiment herein, if the list is not configured/signaled by the HPLMN (or the EHPLMN) in the UE 502, then the UE 502 determines that the list is not present, or the list is empty. In an embodiment herein, if the list is not stored or maintained in the UE 502 (either in ME or in the USIM), then the UE 502 determines that the list is not present, or the list is empty. In an embodiment herein, if the list is not stored or maintained in the UE 502 (either in ME or in the USIM), then the UE 502 shall create a list with zero entries. In an embodiment herein, this list is stored in the ME after switching OFF and switching ON; i.e., power cycle or reboot. In an embodiment herein, the list is removed/deleted from the ME after switching off and switching ON; i.e., power cycle or reboot. The list is maintained by the UE 502 till a new USIM is inserted in the UE 502. In an embodiment herein, this list is cleared or deleted by the UE 502, if the USIM is removed and re-inserted. In an embodiment herein, this list is stored or maintained by the UE 502, if the USIM is removed and re-inserted. The various actions in method 900 may be performed in the order presented, in a different order or simultaneously. Further, in some embodiments, some actions listed in FIG. 9 may be omitted.

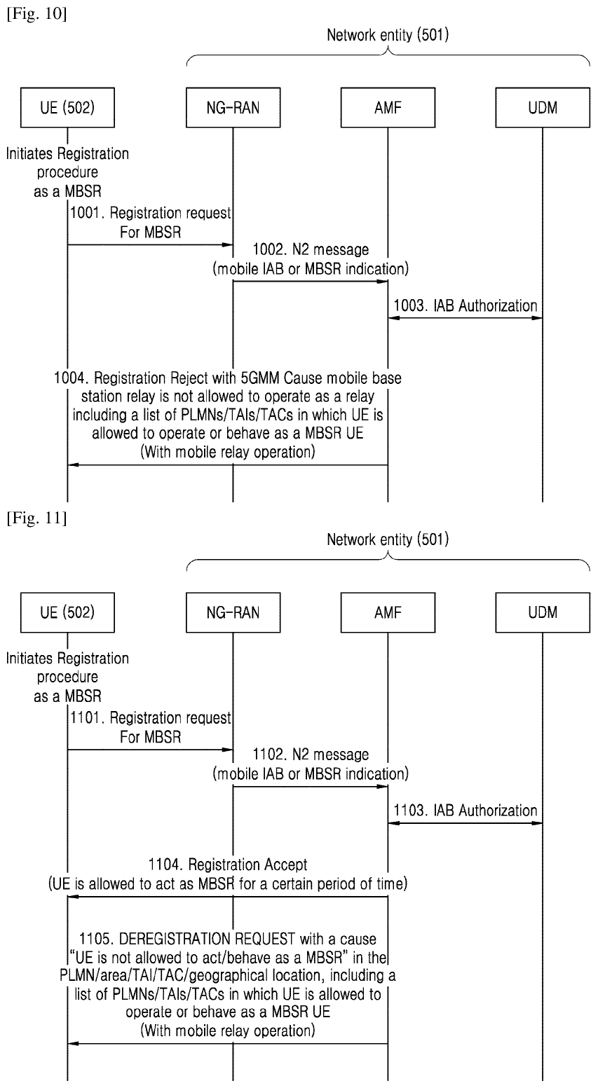

FIG. 10 depicts a process of a UE performing registration or attempting registration to the network. When a UE 502 performs registration or attempts to register to the network (via any AS or NAS signalling message) in any roaming area or any VPLMN or on any selected PLMN as a UE (with mobile base station relay operation)/UE (MBSR) or if the UE performs handover or performs any mobility registration procedure (for example, with 5GS Registration Type “mobility registration updating” etc.), optionally using the IAB authorization, if the network or any Network entity/function (such as the AMF) determines that the UE 502 is not allowed to operate as a Mobile Base Station Relay (MBSR) in the selected or camped PLMN, then a network entity 501 (for example, NG-RAN/AMF) shall reject the Registration Request of the UE 502 with a 5GMM cause value indicating that the UE 502 is not allowed to operate as a relay and shall provide a list of PLMNs/TAIs/TACs via a NAS signalling message (for example, REGESTRATION REJECT message) in which the UE 502 is allowed to operate or behave as a MBSR UE (With mobile relay operation). Optionally, the network entity 501 (for example, NG-RAN/AMF) shall provide a list of PLMNs/TAIs/TACs/area via a NAS signalling message (for example, REGESTRATION REJECT message or REGISTRATION ACCEPT message) in which the UE 502 is not allowed to operate or behave as a MBSR UE (with mobile relay operation) or the UE 502 is allowed to operate or behave as a normal UE only (i.e., a UE 502 without mobile base station relay operation).

In step 1001, the mobile base station relay (MBSR) (UE with MBSR operation) initiates a registration procedure and indicates its intention to operate as a MBSR in RRC connection or any AS/NAS signaling message to the network entity 501 (for example, NG-RAN). In step 1002, the network entity or function 501 may include the UE's Capability to operate as a MBSR in a suitable message/parameter while indicating to other network entities 501 (for example, the intention of UE to operate as a MBSR may be included in the N2 parameters to the AMF by the NG-RAN). In step 1003, the AMF may perform the MBSR authorization (IAB-authorization) for the UE with the UDM. The AMF or any other network entity 501 may determine whether the UE 502 is allowed to operate as a MBSR in the selected or camped PLMN or not. In step 1004, if the network entity 301 (for example, AMF or AUSF or UDM etc.) determines that the UE 502 is not allowed to operate as a MBSR in the selected or camped PLMN or TAI, the network entity 501 (for example, AMF or the NG-RAN) shall reject the Registration Request of the MBSR with optionally, a 5GMM cause value or any indication indicating that the MBSR is not allowed to operate as a relay and shall provide a list of PLMNs/TAIs/TACs via a NAS signalling message (for example, REGESTRATION REJECT message) in which the UE 502 is allowed to operate or behave as a MBSR UE (with mobile relay operation). Optionally, the network entity 501 (for example, NG-RAN/AMF) shall provide a list of PLMNs/TAIs/TACs/area via NAS or AS signalling message (for example, REGESTRATION REJECT message or REGISTRATIN ACCEPT or DL NAS TRANSPORT or UE CONFIGURATION UPDATE message, for the list of possible NAS messages, please refer to TS 24.501; for a list of AS messages please refer to TS 38.331) in which the UE 502 is not allowed to operate or behave as a MBSR UE (with mobile relay operation) or the UE 502 is allowed to operate or behave as a normal UE only (i.e., UE 502 without mobile base station relay operation).

FIG. 11 depicts a process of a UE performing registration or attempting registration to the network. When a UE 502 performs registration or attempts to register to the network (via any AS or NAS signalling message) in any roaming area or any VPLMN or on any selected PLMN as a UE 502 (with MBSR operation)/UE (MBSR) or if the UE performs handover or performs any mobility registration procedure (for example, with 5GS Registration Type “mobility registration updating” etc.), optionally using the IAB authorization, if the network or any network entity/function (such as AMF) determines that the UE 502 is allowed to operate as a MBSR in the selected or camped PLMN for a certain time-period/time-slot/time-window/time maybe due to subscription or any other reason, then the network entity 501 (for example, NG-RAN/AMF) shall accept the Registration Request of the UE to act/behave as a mobile base station relay.

After the expiry of the time-period/time-slot/time-window/time or after the subscription has expired or PLMN determines that the UE 502 is now not allowed to act as MBSR for any reasons like operator policy or roaming agreements etc., then the network entity 501 (for example, NG-RAN/AMF) shall indicate to the UE via a NAS signalling message (for example, DEREGISTRATION REQUEST message) with a cause “UE is not allowed to act/behave as a MBSR” in the PLMN/area/TAI/TAC/geographical location and shall provide a list of PLMNs/TAIs/TACs via a NAS signalling message (for example, DEREGISTRATION REQUEST message) in which the UE is allowed to operate or behave as a MBSR UE (with mobile relay operation).

Optionally, the network entity 501 (for example, NG-RAN/AMF) shall indicate to the UE 502 via a NAS signalling message (for example, DEREGISTRATION REQUEST message) with a cause “UE is not allowed to act/behave as a MBSR” in the PLMN/area/TAI/TAC/geographical location and shall provide a list of PLMNs/TAIs/TACs via a NAS signalling message (for example, DEREGISTRATION REQUEST message) in which the UE 502 is not allowed to operate or behave as a MBSR UE (with mobile relay operation) or the UE 502 is allowed to operate or behave as a normal UE only (i.e., UE 502 without MBSR operation).

In step 1101, the MBSR (UE with mobile base station relay operation) initiates a registration procedure and indicates its intention to operate as a MBSR in RRC connection or any AS/NAS signaling message to the network entity 502 (for example, NG-RAN). In step 1102, the network entity or function 501 may include the UE's Capability to operate as a MBSR in any of the message/parameter while indicating to other network entities 501 (for example, the intention of UE to operate as a MBSR may be included in the N2 parameters to the AMF by the NG-RAN). In step 1103, the AMF may perform the MBSR authorization (IAB-authorization) for the UE 502 with the UDM. The AMF or any other network entity may determine whether the UE 502 is allowed to operate as a MBSR in the selected or camped PLMN or not. In step 1104, if the network entity 501 (such as AMF) determines that the UE 502 is allowed to operate as a MBSR in the selected or camped PLMN (in an example for a certain time-period/timeslot/time-window/time), or may be due to subscription or any other reason, then the network entity 501 (for example, NG-RAN/AMF) shall accept the Registration Request of the UE 502 to act/behave as a MBSR. In step 1105, after the expiry of the time-period/time-slot/time-window/time or after the subscription has expired or PLMN determines that the UE 502 is now not allowed to act as MBSR, then the network entity 501 (for example, NG-RAN/AMF) shall indicate to the UE 502 via a NAS signalling message (for example, DEREGISTRATION REQUEST message) with a cause “UE is not allowed to act/behave as a MBSR” in the PLMN/area/TAI/TAC/geographical location and shall provide a list of PLMNs/TAIs/TACs via a NAS signalling message (for example, DEREGISTRATION REQUEST message) in which the UE 502 is allowed to operate or behave as a MBSR UE (with mobile relay operation). Optionally the network entity 501 (for example, NG-RAN/AMF) shall indicate to the UE 502 via a NAS signalling message (for example, DEREGISTRATION REQUEST message) with a cause “UE is not allowed to act/behave as a MBSR” in the PLMN/area/TAI/TAC/cell/geographical location and shall provide a list of PLMNs/TAIs/TACs/cell/area via a NAS signalling message (for example, DEREGISTRATION REQUEST message) in which the UE 502 is not allowed to operate or behave as a MBSR UE (with mobile relay operation) or the UE 502 is allowed to operate or behave as a normal UE only (i.e., UE 502 without mobile base station relay operation). If the network does not indicate explicitly the areas/TAI/cells to the UE, then the UE implicitly determines the current camped area/cell/TAI/PLMN as a forbidden area for MBSR operations. The UE shall not attempt to act as MBSR; i.e., the UE shall not indicate support/capability/intention to operate as a MBSR to the network (such as NG-RAN/AMF) in an AS or NAS signaling message.

The cause names in this embodiment are for illustration purpose and it can have any name. The non-access stratum (NAS) messages and access stratum (AS) messages described in this embodiment is only for illustration purpose it can be a NAS or AS messages as per defined protocol between the UE and the network entity 501 (such as, but not limited to, the AMF, the gNB (NG-RAN/any RAN node), and so on).

In an example herein, the AMF may provide the list of PLMN/area/TAI/TAC/geographical location to the UE 502, where the UE 502 is allowed to operate as MBSR in a NAS or AS message.

In an example herein, the AMF may provide the list of PLMN/area/TAI/TAC/geographical location to the UE 502, where the UE 502 is not allowed to operate as MBSR in a NAS or AS message.

Based on the above information, the UE 502 decides whether it has to act as MBSR or not act as MBSR in a given PLMN/area/TAI/TAC/geographical location etc.

In an example herein, the AMF may provide the list of PLMN/area/TAI/TAC/geographical location to the RAN node (like gNB or NR node or NG-eNB etc.), where the UE 502 is not allowed to operate as MBSR in any of the S1-AP messages or N2 interface, i.e., in general over the interface between the AMF and the RAN node. If the UE accesses from the PLMN/area/TAI/TAC/geographical location, the RAN node will reject the request to access in any of the AS messages and provide the list of PLMN/area/TAI/TAC/geographical location to the UE where the UE 502 is not allowed to operate as MBSR to the UE 502. Based on the above information, the UE 502 decides whether it has to act as MBSR or not act as MBSR in a given PLMN/area/TAI/TAC/geographical location etc.

In an example herein, the AMF may provide the list of PLMN/area/TAI/TAC/geographical location to the RAN node (like gNB or NR node or NG-eNB etc.) where the UE 502 is allowed to operate as MBSR in any of the S1-AP messages or N2 interface, i.e., in general over the interface between AMF and RAN node. If the UE 502 accesses from the PLMN/area/TAI/TAC/geographical location, the RAN node will reject the request to access in any of the AS messages and provide the list of PLMN/area/TAI/TAC/geographical location to the UE where the UE 502 is allowed to operate as MBSR to the UE 502. Based on the above information, the UE 502 decides whether it has to act as MBSR or not act as MBSR in a given PLMN/area/TAI/TAC/geographical location etc.

The list of AS messages can be for e.g., RRC resume request, RRC establishment request etc., for all the list of AS messages please refer to 38.331.

If a cause is indicated to the UE 502 (in general an indication is provided to the UE) that it is not allowed to act as MBSR and optionally, if there is no associated list provided indicating PLMN/area/TAI/TAC/geographical location, where the UE 502 is allowed/not allowed to operate as MBSR to the UE 502 and optionally, if there is no associated list provided indicating PLMN/area/TAI/TAC/geographical location where the UE 502 is allowed to operate as MBSR to the UE 502, then the UE 502 can mark the current PLMN/area/TAI/TAC/geographical location as not allowed to operate as MBSR.

In an embodiment herein, the UE acting as a MBSR implies that the UE will indicate its intention to operate as a MBSR as part of a NAS or AS signaling message to the network.

In an embodiment herein, the UE not acting as a MBSR implies that the UE will not indicate its intention to operate as a MBSR as part of a NAS or AS signaling message to the network.

The geographical location can be, for e.g., a cell of a given NG-RAN or any other unit indicating a given area etc.

The embodiments disclosed herein can be implemented through at least one software program running on at least one hardware device and performing network management functions to control the elements. The elements shown in FIGS. 4, and 6 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

1. A method performed by a user equipment (UE) in a wireless communication system, the method comprising:
attempting to act as a mobile station relay (MBSR); and
receiving, from an access and mobility management function (AMF),
an indication that the UE is not allowed to act as the MBSR,
wherein the UE is not allowed to act as the MBSR in a location in response to receiving the indication.

2. The method of claim 1,
wherein the indication is included in a registration reject message.

3. The method of claim 1,
wherein whether the MBSR is allowed is determined based on subscription data of the UE.

4. The method of claim 1,
wherein the location is included in a list of tracking area identity (TAI)s where the UE is not allowed to act as the MBSR.

5. The method of claim 1,
wherein the location is added to a forbidden public land mobile network (PLMN) list for the MBSR.

6. The method of claim 1, further comprising:
triggering a registration procedure for operating as the MBSR, if the UE is not present in a forbidden area.

7. The method of claim 1, further comprising:
entering a limited service state or PLMN search state; and
performing PLMN selection procedure.

8. A user equipment (UE) in a wireless communication system, the UE comprising:
a transceiver; and
at least one processor coupled with the transceiver and configured to:
attempt to act as a mobile station relay (MBSR), and
receive, from an access and mobility management function (AMF), an indication that the UE is not allowed to act as the MBSR,
wherein the UE is not allowed to act as the MBSR in a location in response to receiving the indication.

9. The UE of claim 8,
wherein the indication is included in a registration reject message.

10. The UE of claim 8,
wherein whether the MBSR is allowed is determined based on subscription data of the UE.

11. The UE of claim 8,
wherein the location is included in a list of tracking area identity (TAI)s where the UE is not allowed to act as the MBSR.

12. The UE of claim 8,
wherein the location is added to a forbidden public land mobile network (PLMN) list for the MBSR.

13. The UE of claim 8,
wherein the at least one processor is further configured to:
trigger a registration procedure for operating as the MBSR, if the UE is not present in a forbidden area.

14. The UE of claim 8,
wherein the at least one processor is further configured to:
enter a limited service state or PLMN search state, and perform PLMN selection procedure.

15. A method performed by an access and mobility management function (AMF) in a wireless communication system, the method comprising:
transmitting, to a user equipment (UE), an indication that the UE is not allowed to act as the MBSR, if the UE attempts to act as a mobile station relay (MBSR),
wherein the UE is not allowed to act as the MBSR in a location in response to receiving the indication.
